(19) United States
(12) Patent Application Publication
(10) Pub. No.: US 2004/0065491 A1
(43) Pub. Date: Apr. 8, 2004

(54) Method and apparatus for cooling a vehicle battery

(76) Inventors: Paul L. Dudley, Fostoria, MI (US); Ramesh Kumar Goyal, Rochester Hills, MI (US); Shailendra Kaushik, Beverly Hills, MI (US)

Correspondence Address: CHRISTOPHER DEVRIES, General Motors Corporation, Legal Staff, Mail Code 482-C23-B21, P.O. Box 300, Detroit, MI, 48265-3000, US

(21) Appl. No.: 10/264,695

(22) Filed: Oct. 4, 2002

(51) Int. Cl. B60R 16/04

(52) U.S. Cl. 180/68.5

(57) ABSTRACT

A method and apparatus for cooling a vehicle battery, comprising providing a container for enclosing the battery to isolate the battery from the vehicle under-hood environment, the container being substantially sealed except for a cooling air inlet and an air exhaust port, providing an air scoop to direct relatively cool air from external to the vehicle to the cooling air inlet, and forcing the cooling air around the battery toward the exhaust port, and forcing the cooling out of the exhaust port. Additionally, a battery container is provided comprising a base for holding the battery, the base having a floor and upwardly extending sides for part of the height of the battery; and a cover for the container having a top and sides extending downward to meet the upwardly extending sides, the cover and the base having mating seals to form a substantially airtight container. An air scoop is provided, oriented to accept cooling air when the vehicle is in motion. The air scoop cooperates with the battery container to direct the cooling air toward and around the battery. The container has air exit slots arranged such as to allow the cooling air to escape from the container at a rate to allow cooling of the battery.

### TECHNICAL FIELD

The present invention relates to a method and apparatus for cooling a vehicle battery, and more particularly to a method for applying cooling air to a battery while isolating the battery from the under-hood environment of a motor vehicle.

### BACKGROUND OF THE INVENTION

Premature battery failures in motor vehicles, particularly failures within the first two years of vehicle operation, are a major concern of vehicle manufacturers. Through extensive analysis of such failures it has been determined that premature battery failure is caused primarily by high battery cell temperatures, a result of the battery being exposed to excessive heat in the under-hood environment. Optimally, battery cell temperatures should be held to below 52° C. (125° F.) in normal driving conditions and below 60° C. (140° F.) during all driving conditions.

In the past, the most common battery protection method has been the use of a battery blanket consisting of a thermal wrap installed around the battery to provide an insulative barrier. Thermal performance tests in the past have shown that the thermal blanket is capable of reducing battery temperatures only about 8° C. where a reduction of 20 to 30° C. is needed. Another disadvantage of the battery blanket is that the blanket, after a long period, holds in heat instead of dissipating it away from the battery.

Other methods of protecting batteries have included using the engine air induction system using engine vacuum pressure to route air along the side of the battery, providing a thermal barrier of cool air on one side of the battery.

### SUMMARY OF THE INVENTION

The above disadvantages are overcome in the instant invention by providing a method and apparatus for cooling a vehicle battery, comprising providing a container for enclosing the battery to isolate the battery from the vehicle under-hood environment, the container being substantially sealed except for a cooling air inlet and an air exhaust port, providing an air scoop to direct relatively cool air from external to the vehicle to the cooling air inlet, and forcing the cooling air around the battery toward the exhaust port, and forcing the cooling out of the exhaust port.

Additionally, a battery container is provided comprising: a base for holding the battery, the base having a floor and upwardly extending sides for part of the height of the battery; a cover for the container having a top and sides extending downward to meet the upwardly extending sides; the cover and the base having mating seals to form a substantially airtight container. An air scoop is provided, oriented to accept cooling air when the vehicle is in motion, the air scoop cooperating with the battery container to direct the cooling air toward and around the battery; the container having air exit slots arranged such as to allow the cooling air to escape from the container at a rate to allow cooling of the battery.

### BRIEF DESCRIPTION OF THE DRAWINGS

The present invention will hereinafter be described in conjunction with the appended drawing figures, wherein like numerals denote like elements, and:

FIG. 1 is a schematic diagram of a battery container according to the instant invention;

FIG. 2 is a perspective view of a battery container according to the invention;

FIG. 3 is a perspective view of an alternative embodiment of the top of a battery container according to the invention; and

FIG. 4 is a perspective view of another alternative embodiment of a battery tray according to the invention.

### DESCRIPTION OF THE PREFERRED EMBODIMENT

The following detailed description of preferred embodiments is merely exemplary in nature and is not intended to limit the invention or the application and uses of the invention.

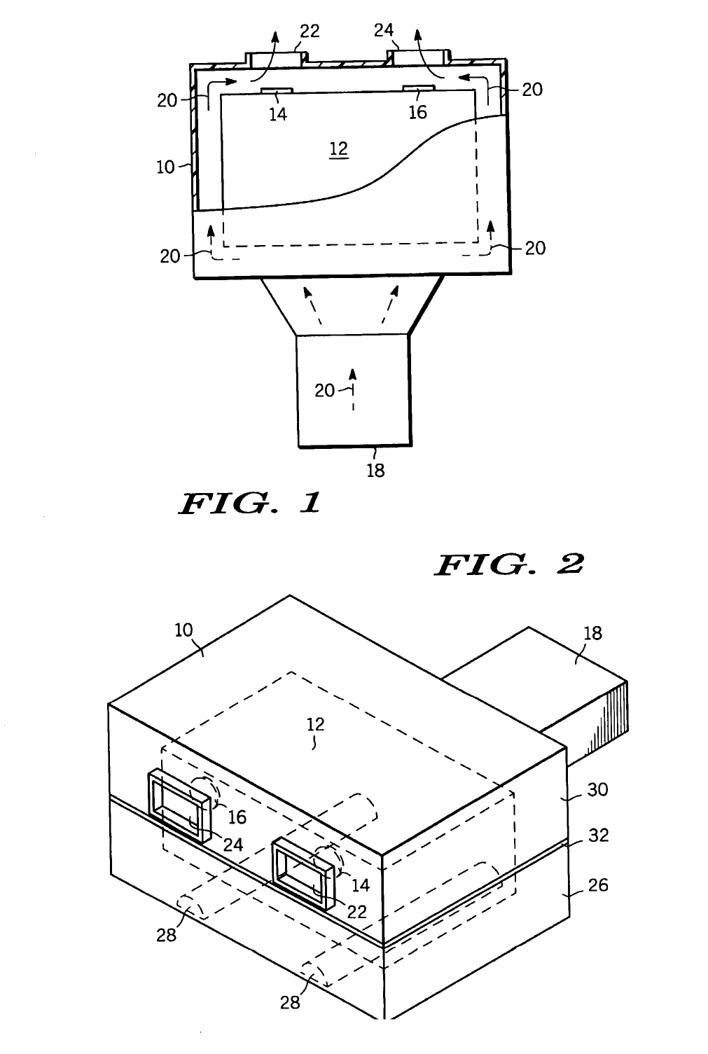

FIG. 1 generally shows a battery container 10, within which is a battery 12 having side-mounted electrodes or terminals 14 and 16 for connection to battery cables (not shown). The battery container is substantially sealed on all six sides except for air intake and exhaust ports in order to isolate the battery from the vehicle under-hood environment and to provide a path for air entering and exiting the battery container. The schematic of FIG. 1, for purposes of simplicity and clarity of exposition, does not show the entirety of the battery container with its six sides.

An air intake 18 is positioned with respect to the vehicle such that fresh, cool air, preferably ram air from the front of the vehicle, is taken into the battery container 10. The air flow path as shown by the arrows 20 causes the fresh air from the air intake 18 to circulate around the battery 12 to provide convective cooling of the battery as the vehicle moves. A pair of openings 22 and 24 are provided adjacent to the battery terminals 14 and 16 to route the fresh air out of the battery container. The openings 22 and 24 may also provide a path for the battery cables (not shown) to be connected to the battery terminals 14 and 16. The battery container, the air intake port 18 and the exhaust ports 22 and 24 are designed for a particular vehicle and particular operating conditions to optimize the airflow for the most efficient cooling of the battery 12.

FIG. 2 is a perspective view of a battery container according to the invention. In this and in other figures like elements use the same numbers. The battery container 10 is shown having a battery 12 therein. The battery 12 has terminals 14 and 16, shown here as in FIG. 1 as side mounted, but which can be alternatively mounted on top of the battery 12 or elsewhere. An air intake duct 18 is shown as providing a path into the battery container for fresh cooling air. Output ports 22 and 24 provide an exit path for the fresh air after circulation around the battery 12.

The battery container 10 of FIG. 2 has a battery tray 26 on which the battery 12 rests. As can be seen, the battery tray extends part way up the sides of the battery, but can be of any height which affords proper construction of the container. The battery tray may have ribs 28 to elevate the battery slightly to allow airflow under the battery if necessary for proper cooling flow. The top 30 of the battery container 10 has ports 22 and 24 provided therein to allow connection of battery cables (not shown) to the battery terminals 14 and 16. The top 30 of the battery container 10 is coupled to the battery tray 26 by means of an effective seal 32 which joins the tray 26 to the top 30. The seal should be airtight to ensure proper airflow from the intake duct 18 to the exhaust ports 22 and 24. An airtight seal is also necessary to enable the forced circulating air to overcome the high under-hood pressures which exist in vehicles. Any effective seal may be used; for example, a tongue and groove seal has been found to be quite effective.

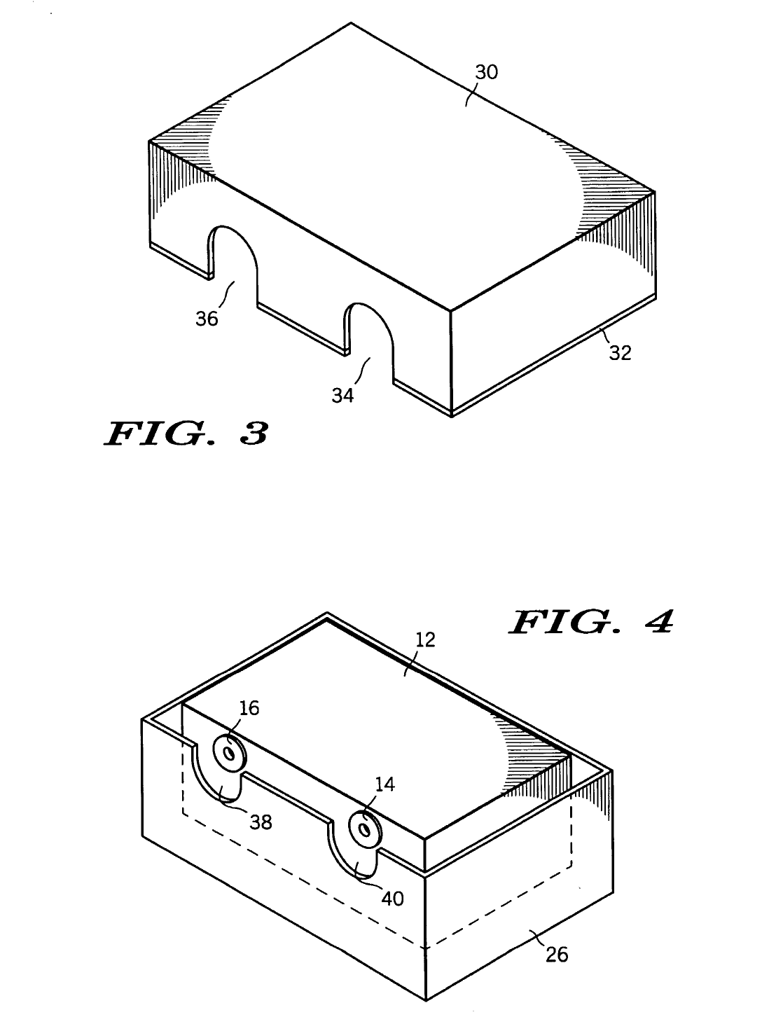

FIG. 3 is a perspective view of an alternative embodiment of the top 30 of a battery container according to the invention showing the seal 32 for mating with a lower portion or tray of the battery container. The positive and negative battery cables may be difficult to install or attach or detach to or from the battery terminals 12 and 14 in FIGS. 1 and 2 through ports cut into the top 30 of the battery container. In FIG. 3, instead of providing ports cut into the top 30, slots 34 and 36 are provided to allow access to the battery terminals prior to sealing the battery container top 30 to the tray. Alternatively, a single slot wide enough to accommodate the battery cables and sized properly for cooling of the battery could be provided.

FIG. 4 is a perspective view of an alternative embodiment of a battery tray according to the invention. The lower portion of the battery container, or tray 26, is shown with a battery 12 resting thereon. The battery 12 has terminals 14 and 16 to which battery cables are to be attached. In this embodiment, similarly as in the embodiment of FIG. 3, instead of ports 22 and 24 as in FIG. 2, for ease of assembly and repair, slots 38 and 40 are provided in the sides of the tray adjacent the battery terminals 14 and 16 to allow attachment of the battery cables prior to sealing the battery container.

In all cases, the sizes of the intake port and the exhaust ports are determined by the airflow required around the battery for proper cooling. As can be seen, it would also be possible to have a single exhaust port or multiple intake ports if properly sized and located to provide proper cooling of the battery. The shape of the battery container, the amount of air flow and the operating environment will also be determined by the amount of airflow desired for a particular installation.

From the foregoing detailed description of preferred exemplary embodiments, it should be appreciated that apparatus and methods are provided for cooling a battery in a vehicle by providing a method and apparatus for cooling a vehicle battery, comprising providing a container for enclosing the battery to isolate the battery from the vehicle under hood environment, the container being substantially sealed except for a cooling air inlet and an air exhaust port, providing an air scoop to direct relatively cool air from external to the vehicle to the cooling air inlet, and forcing the cooling air around the battery toward the exhaust port, and forcing the cooling out of the exhaust port.

While preferred exemplary embodiments have been presented in the foregoing detailed description of preferred exemplary embodiments, it should be appreciated that a vast number of variations exist. It should also be appreciated that these preferred exemplary embodiments are only examples, and are not intended to limit the scope, applicability, or configuration of the invention in any way. Rather, the ensuing detailed description will provide those skilled in the art with a convenient road map for implementing a preferred embodiment of the invention, it being understood that various changes may be made in the function and arrangement of elements described in an exemplary preferred embodiment without departing from the spirit and scope of the invention as set forth in the appended claims.

1. A method for cooling a vehicle battery, comprising:
providing a container for enclosing the battery to isolate the battery from the vehicle under-hood environment,
the container being substantially sealed except for a cooling air inlet and an air exhaust port,
providing an air scoop to direct relatively cool air from external to the vehicle to the cooling air inlet,
forcing the cooling air around the battery toward the exhaust port, and forcing the cooling air out of the exhaust port.

2. A method as set forth in claim 1 wherein the air scoop is in the front of the vehicle such as to provide the cooling air with substantial force.

3. A method as set forth in claim 1 wherein the battery has terminals to receive battery cables, and the exhaust port of the container is located adjacent to the battery terminals to provide access to the battery terminals from outside of the container.

4. A method as set forth in claim 3 wherein the battery terminals are side-mounted terminals.

5. A method as set forth in claim 1 wherein the container has a cover and the exhaust ports are slots in the container cover.

6. A method as set forth in claim 5 wherein the battery has terminals for receiving battery cables and the exhaust ports are located adjacent to the battery terminals.

7. A container for a vehicle battery comprising:
a base for holding the battery, the base having a floor and upwardly extending sides for part of the height of the battery;
a cover for the container having a top and sides extending downward to meet the upwardly extending sides;
the cover and the base having mating seals to form a substantially airtight container;
an air scoop oriented to accept cooling air when the vehicle is in motion, the air scoop cooperating with the battery container to direct the cooling air toward and around the battery;
the container having air exit slots arranged such as to allow the cooling air to escape from the container at a rate to allow cooling of the battery.

8. A container as set forth in claim 1 wherein the air scoop is mounted in the front of the vehicle to receive cool air.

9. A container as set forth in claim 7 where the air scoop provides cooling air to the battery and where the exit ports are oriented such as to provide airflow substantially around the battery.

10. A container as set forth in claim 9 wherein the exit holes are sized such as to control the amount of airflow through the container.

11. A container as set forth in claim 8 wherein the battery has terminals to accept battery cables and the air exit ports are located adjacent to the battery terminals to allow access to the terminals.

12. A container as set forth in claim 8 wherein the exit ports are formed in the container cover.

13. A container as set forth in claim 8 wherein the exit ports are formed as slots in the container cover.

14. A container as set forth in claim 11 wherein the battery has side-mounted terminals and the exit ports comprise slots for access to the terminals.

15. A container as set forth in claim 14 wherein the exit air path comprises slots in the cover of the battery terminal.
